(19) United States
(12) Patent Application Publication
(10) Pub. No.: US 2018/0124876 A1
(43) Pub. Date: May 3, 2018

(54) Thermal Controlled Hose Assembly for Dispensing Fluid

(71) Applicant: Mark C. Diebott, Old Lyme, CT (US)

(72) Inventors: Mark C. Diebolt, Old Lyme, CT (US); Christopher T. May, Old Lyme, CT (US); Terence C. Murphy, Cliffside Park, NJ (US)

(21) Appl. No.: 15/795,340

(22) Filed: Oct. 27, 2017

Related U.S. Application Data
(60) Provisional application No. 62/413,707, filed on Oct. 27, 2016.

(51) Int. Cl. H05B 3/58; F01N 3/20; F16L 53/00

(52) U.S. Cl. CPC H05B 3/58; F01N 3/206; F01N 2610/1486; F01N 3/2066; F16L 53/008

(57) ABSTRACT

A thermal controlled hose assembly is provided and includes a hose, wherein the hose defines a hose cavity, a nozzle, wherein the nozzle includes an inlet port and an outlet port and defines a fluid flow channel which communicates the inlet port with the outlet port, a flow control means, wherein the flow control means is associated with the fluid flow channel to control the flow of a fluid flowing through the fluid flow channel and a heating cable, wherein the heating cable is associated with the fluid flowing within the fluid flow channel and is configured to warm the fluid to a predetermined temperature range.

### CROSS REFERENCE TO RELATED APPLICATIONS

This application is related to and claims the benefit of the filing date of U.S. Provisional Patent Application Ser. No. 62/413,707 filed Oct. 27, 2016, the contents of which are incorporated herein by reference in its entirety.

### FIELD OF THE INVENTION

This invention relates generally to a hose assembly for dispensing fluid and more particularly to a thermal controlled hose assembly for dispensing Diesel Exhaust Fluid (DEF).

### BACKGROUND OF THE INVENTION

Diesel engines are well known and are used in many trucks and cars as an alternative to gas engines. A diesel engine is an internal combustion engine in which the ignition of diesel fuel is achieved by spraying diesel fuel into a combustion chamber which contains air that is under such great pressure that the air is hot enough to ignite the diesel fuel being introduced. Diesel Exhaust Fluid or DEF is an aqueous urea solution that is used as a consumable in Selective Catalytic Reduction (SCR) in order to lower the NOx concentrations in the diesel exhaust emissions from a diesel engine. This is accomplished by storing the DEF in a tank on-board the vehicle and injecting the DEF into the hot exhaust stream via a metering system. The DEF interacts with the diesel exhaust to achieve an overall reduction of NOx. DEF has proved to be an economical, safe and efficient answer to reducing engine emissions and increasing vehicle millage ratings. In fact, over the road Tier IV trucks and diesel powered cars are required to use DEF to decrease engine emissions via SCR systems installed on the engines

To accommodate on-board storage of DEF, fuel stations are offering DEF to consumers via DEF pump, in which DEF is administered at pumps similarly to diesel fuel, where the DEF pumps are often located adjacent to the diesel fuel pumps so that the vehicle operator can fill up on both without having to move the vehicle. Unfortunately however, the freezing point of DEF is about 12° F. As such, when the outside temperature reaches or drops below 12° F., the DEF within the dispensing hose freezes and can no longer be dispensed. This is undesirable because these vehicles cannot be operated without DEF due to government requirements and due to severe damage that may occur to the diesel engines when operated without DEF.

### SUMMARY OF THE INVENTION

A thermal controlled hose assembly is provided and includes a hose, wherein the hose defines a hose cavity, a nozzle, wherein the nozzle includes an inlet port and an outlet port and defines a fluid flow channel which communicates the inlet port with the outlet port, a flow control means, wherein the flow control means is associated with the fluid flow channel to control the flow of a fluid flowing through the fluid flow channel and a heating cable, wherein the heating cable is associated with the fluid flowing within the fluid flow channel and is configured to warm the fluid to a predetermined temperature range

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike:

FIG. 1 illustrates a side view of a thermal controlled hose assembly connected to a fluid dispensing nozzle, in accordance with one embodiment of the invention.

FIG. 2 illustrates a side view of a thermal controlled hose assembly connected to a fluid dispensing nozzle with a heater cable on the exterior of the hose, in accordance with another embodiment of the invention.

FIG. 3 illustrates a side view of a thermal controlled hose assembly connected to a fluid dispensing nozzle, in accordance with yet another embodiment of the invention.

### DETAILED DESCRIPTION OF THE INVENTION

As disclosed herein with regards to an exemplary embodiment, a unique and novel thermally controllable hose assembly (HH) is provided and allows for the dispensing of DEF in cold climates where temperatures can fall below 12° F. Additionally, the present invention may be used in a wide variety of DEF dispensing applications, such as for example job site dispensing trucks for dispensing DEF to construction equipment operated by diesel engines, diesel equipped re-fueling stations such as large truck stops on major highways and any other diesel dispensing station that also offers DEF dispensing in climates that drops below 12° F. and down to −40° F. It should be appreciated that the present invention is rated and meets the required standard per US electrical code CLASS 1 Division 1—Explosion proof.

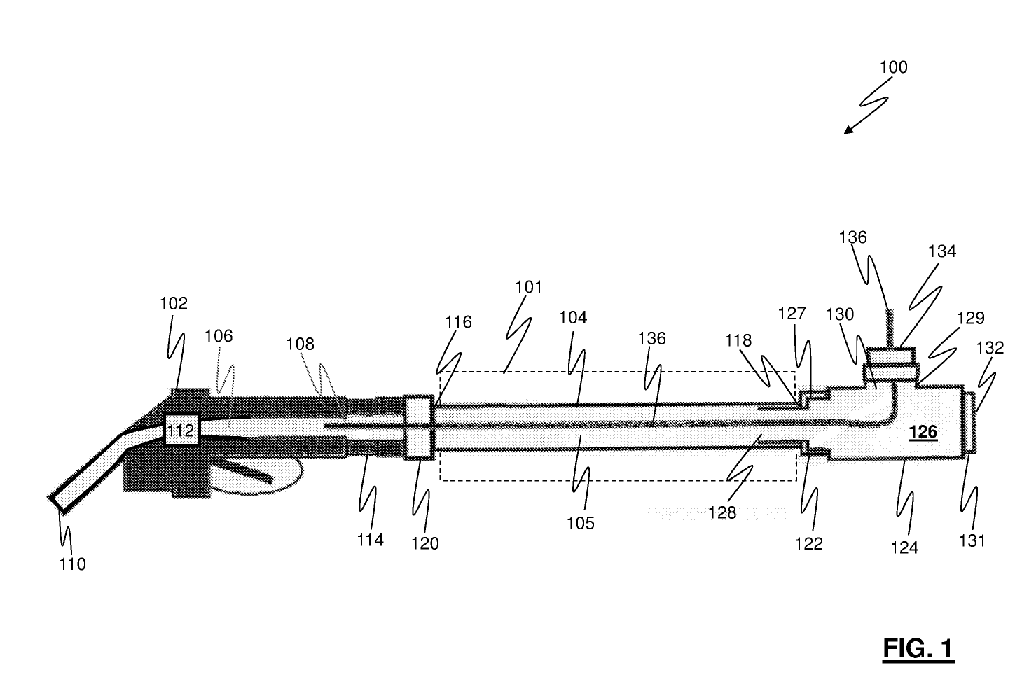

Referring to FIG. 1, one embodiment of a thermal controlled hose assembly 100 is provided and includes a nozzle 102 and a hose 104 which defines a hose cavity 105, wherein the nozzle 102 defines a fluid flow channel 106 and includes an inlet port 108 communicated with an outlet port 110 via the fluid flow channel 106. A flow control means 112 (such as a flow control valve) is provided, wherein the flow control means 112 is communicated with the fluid flow channel 106 to control the volume and/or flow rate of the fluid being dispensed out of the outlet port 110. A swivel joint 114 (configured as male) is included and is associated with the nozzle 102 to be communicated with the inlet port 108 such that fluid flowing into the swivel joint 114 flows through the swivel joint 114 and into the fluid flow channel 106. The hose 104 includes a first hose end 116 and a second hose end 118, wherein the first hose end 116 is connected to the swivel joint 114 via a first BSPP pipe fitting 120 (configured as female). Furthermore, the hose 104 also includes a second BSPP pipe fitting 122 (configured as female) associated with the second hose end 118 of the hose 104. The first hose end 116 is communicated with the second hose end 118 via the hose cavity 105. When assembled together, the hose cavity 105 is communicated with the inlet port 108.

An adapter 124 (in this embodiment a “T” style adapter) is provided and is connected to the second hose end 118 of hose 104 via the second BSPP pipe fitting 122. The adapter 124 defines an adapter cavity 126 and includes a first adapter end 127 defining a first adapter opening 128, a second adapter end 129 defining a second adapter opening 130 and a third adapter end 131 defining a third adapter opening 132, wherein each of the first adapter opening 128, second adapter opening 130 and third adapter opening 132 are communicated with the adapter cavity 126. The adapter 124 further includes an adapter opening cover 134 associated with the adapter 124 to cover and seal the second adapter opening 130. It should be appreciated that when the adapter 124 is associated with the second hose end 118, the adapter cavity 126 is communicated with the hose cavity 105 via the first adapter opening 128. The thermal controlled hose assembly 100 further includes a heating cable 136 which is introduced into the adapter cavity 126 via the adapter opening cover 134 which is configured to allow the heating cable 136 to be communicated with the adapter cavity 126 while still sealing the second adapter opening 130. The heating cable 136 is associated with the thermal controlled hose assembly 100 to be located within the adapter cavity 126, the hose cavity 105 and a portion of the fluid flow channel 106 such that when fluid is contained within the adapter cavity 126, the hose cavity 105 and the fluid flow channel 106, the heating cable 136 is located within the fluid.

It should be appreciated that, in one embodiment, the adapter 124 may be an aluminum Tee style adapter wherein the first adapter end 127 is threadingly associated with the second hose end 118 via the second BSPP pipe fitting 120 which may be a 1″ BSPP female fitting. The third adapter end 131 is connected to a hard piping system which is typically located within the overhead mezzanine of a DEF dispensing service station. Lastly the second adapter end 129 may include the adapter opening cover 134 and may be a Female NPT with a liquid tight compression seal to accommodate a male 1″ NPT fitting of a waterproof/leakproof self limiting cable transition exit fitting. It should be further appreciated that the heating cable 136 may be electrically connected to a power source, where the electrical connection will be accomplished in the service station overhead mezzanine. It is contemplated that the adapter 124 may be constructed from any material suitable to the desired end purpose, such as aluminum and/or an cold weather rated thermoplastic.

In accordance with one embodiment of the present invention, at a standard service station the thermal controlled hose assembly 100 may be included in an industry term “3-1&1” configuration with three gasoline grades, diesel fuel and also a DEF dispenser in a familiar “hanging hose” configuration. The heating cable 136 may be a self limiting heating cable 136 which may automatically turn itself off above freezing temperatures and on below 32 F where the heating cable 136 may control its operation up to 8 watts per ft to prevent freezing down to −40 F. The hose 104 may be an 18′ long (the hose 104 can be virtually any length desired, such as for example 210′) DEF specific hose such as, for example a Flextral PE60-100 1″ TruBlue DEF Hose 210 PSI Max ISO-22241, wherein the hose 104 may have a crimped 1″ Female BSPP fitting at each end 116, 118. As mentioned above, the heating cable 136 may be an 8 watt per foot self limiting heating cable 136 which will be installed inside of the hose assembly 100 and which extends all the way past the first and second BSPP fittings 120, 122 and ending within the fluid flow channel 106 of the DEF dispensing nozzle 102. The self limiting cable 136 may be electrically terminated with a waterproof heavy duty rubber cover (which may be about. 2.75″ in length and 0.4″ wide) and which may have a crimped collar for permanent retention to the self limiting heating cable 136.

It should be appreciated that in one embodiment, the thermal controlled hose assembly 100 may include external insulation 101 as desired. For example, the thermal controlled hose assembly 100 may be wrapped in an insulating tape such as (AP/Armaflex black ⅛″ thick, 2″ wide closed cell, mold resistant elastomeric thermal insulation tape). Additionally, the thermal controlled hose assembly 100 may be encapsulated within a 2″ Poly-Urethane hose rated to −65 F, wherein the hose may be configured to offer superior abrasion resistance and/or may be UV stabilized for outdoor use. Moreover, the hose may be blue in color with a blue wear strip making a connection with DEF (this is sometimes called ADBlue etc). Additionally, the 2″ Poly-Urethane hose may have a custom black low temperature rated 3″ long thermoplastic end cap/coupling covering the end of the blue hose on the first hose end 116.

It should be appreciated that the hose core may be changed to a heavy duty DEF hose core (i.e. for example having a 1″ ID and 1.5″ OD manufactured by Novaflex Group. the part number is 4203BE rated at 200 psi Working Pressure). This heavy duty industrial hose may have a ¼″ wall thickness that retains heat that allows the hose to have an internal self limiting heating element (i.e. for example with heat density of 5 watt per ft). In this embodiment, although the live swivel between the hose and dispensing nozzle may need to be insulated, no insulation or urethane jacket would be required and no plastic end fitting would be required. The assembly will still be rated Class 1 Division 1

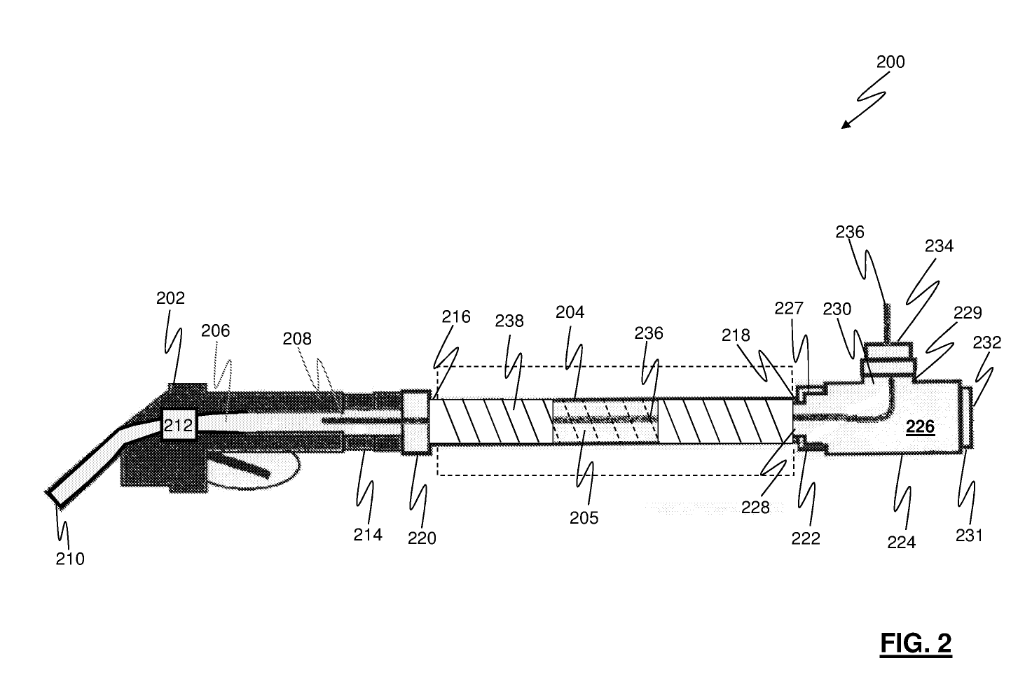

Referring to FIG. 2, another embodiment of a thermal controlled hose assembly 200 is provided and includes a nozzle 202 and a hose 204 which defines a hose cavity 205, wherein the nozzle 202 defines a fluid flow channel 206 and includes an inlet port 208 communicated with an outlet port 210 via the fluid flow channel 206. A flow control means 212 is provided, wherein the flow control means 212 is communicated with the fluid flow channel 206 to control the volume and/or flow rate of the fluid being dispensed out of the outlet port 210. A swivel joint 214 (configured as male) is included and is associated with the nozzle 202 to be communicated with the inlet port 208 such that fluid flowing into the swivel joint 214 flows through the swivel joint 214 and into the fluid flow channel 206. The hose 204 includes a first hose end 216 and a second hose end 218, wherein the first hose end 216 is connected to the swivel joint 214 via a first BSPP pipe fitting 220 (configured as female). Furthermore, the hose 204 also includes a second BSPP pipe fitting 222 (configured as female) associated with the second hose end 218 of the hose 204. The first hose end 216 is communicated with the second hose end 218 via the hose cavity 205. When assembled together, the hose cavity 205 is communicated with the inlet port 208.

An adapter 224 (in this embodiment, as above, a “T” style adapter) is provided and is connected to the second hose end 218 of hose 204 via the second BSPP pipe fitting 222. The adapter 224 defines an adapter cavity 226 and includes a first adapter end 227 defining a first adapter opening 228, a second adapter end 229 defining a second adapter opening 230 and a third adapter end 231 defining a third adapter opening 232, wherein each of the first adapter opening 228, second adapter opening 230 and third adapter opening 232 are communicated with the adapter cavity 226. The adapter 224 further includes an adapter opening cover 234 associated with the adapter 224 to cover and seal the second adapter opening 230.

It should be appreciated that when the adapter 224 is associated with the second hose end 218, the adapter cavity 226 is communicated with the hose cavity 205 via the first adapter opening 228. The thermal controlled hose assembly 200 further includes a heating cable 236 which is introduced into the adapter cavity 226 via the adapter opening cover 234 which is configured to allow the heating cable 236 to be communicated with the adapter cavity 226 while still sealing the second adapter opening 230. The heating cable 236 is associated with the thermal controlled hose assembly 200 to be located within the adapter cavity 226, the hose cavity 205 and a portion of the fluid flow channel 206 such that when fluid is contained within the adapter cavity 226, the hose cavity 205 and the fluid flow channel 206, the heating cable 236 is located within the fluid. The hose assembly 200 includes a self-limiting exterior heater cable 238 which may be wrapped around the exterior of the hose 204, wherein the heater cable 238 may have a power density as desired, such as for example, a 5 watt per foot, 3 watt per foot, an 8 watt per foot, etc. . . . . In one embodiment, the open end of the heater cable 238 may be located on the mezzanine connection end (i.e. adapter 224) of the hose 204 with approximately 56′ (more or less) of heating cable 238 spirally wound around the hose 204 to the first hose end 216 (i.e. the end of the hose nozzle dispensing end) and then back to the mezzanine end (i.e. adapter 224) of the hose 204. This advantageously allows the invention to have an open electrical connection that earns the US electrical code Class 1 Division 1 explosion proof rating. In one embodiment, the heating cable 236 may be secured with 1.5″ wide flexible Silicone tape and the hose with the heating element may be covered with urethane hose cover (as used in previous description). Additionally, in one embodiment, the invention may also retain a black low temp rated plastic also as previously described and the live swivel that connects the heated hose 204 to the dispensing nozzle 216 would need to be covered with insulation as desired to be rated to not have the DEF fluid freeze to −40 F.

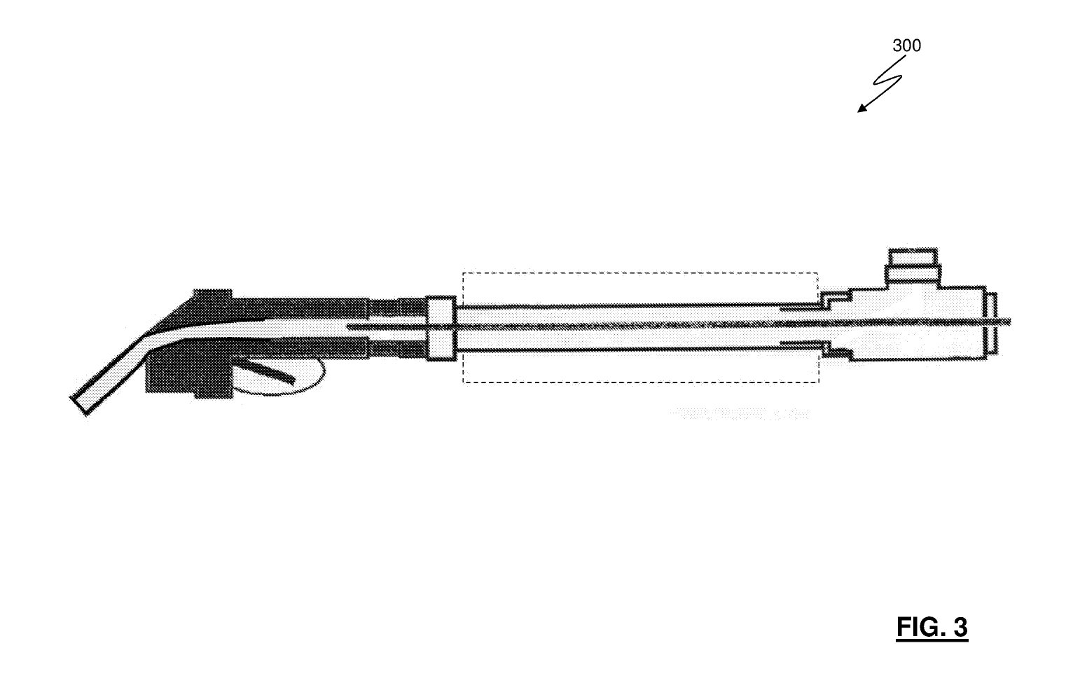

Referring to FIG. 3, in other embodiments, it is contemplated that the heating cable 136, 236 of a thermal controlled hose assembly 300 may be configured to enter the hose 104, 204 via the third adapter end 131, 231 and/or the fluid may be introduced into the hose 104, 204 via the second adapter end 129, 229. This configuration may advantageously put less strain on the heating cable 136, 236.

Moreover, while the invention has been described with reference to an exemplary embodiment, it will be understood by those skilled in the art that various changes, omissions and/or additions may be made and equivalents may be substituted for elements thereof without departing from the spirit and scope of the invention. In addition, the elements and characteristics of the disclosed embodiments may be combined in whole or in part and/or many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

We claim:

1. A thermal controlled hose assembly, the hose assembly comprising:
a hose, wherein the hose defines a hose cavity;
a nozzle, wherein the nozzle includes an inlet port and an outlet port and defines a fluid flow channel which communicates the inlet port with the outlet port;
a flow control means, wherein the flow control means is associated with the fluid flow channel to control the flow of a fluid flowing through the fluid flow channel; and
a heating cable, wherein the heating cable is associated with the fluid flowing within the fluid flow channel and is configured to warm the fluid to a predetermined temperature range.

2. The thermal controlled hose assembly of claim 1, wherein the fluid flow means is a valve.

3. The thermal controlled hose assembly of claim 2, wherein the valve is configured to control at least one of the volume and flow rate of the fluid flowing out of the outlet port.

4. The thermal controlled hose assembly of claim 1, wherein the heating cable is located in at least one of the hose cavity and the fluid flow channel.

5. The thermal controlled hose assembly of claim 1, wherein the heating cable is configured to heat up when the temperature of the fluid falls below approximately 32° F.

6. The thermal controlled hose assembly of claim 1, wherein the predetermined temperature range is above approximately 12° F.
